(19) United States
(12) Patent Application Publication
(10) Pub. No.: US 2014/0082911 A1
(43) Pub. Date: Mar. 27, 2014

(54) FASTENER ASSEMBLY AND METHOD FOR USE IN MAKING REPAIRS

(71) Applicant: The State of Oregon acting by and through the Oregon Department of Transportation, (US)

(72) Inventors: Christopher R. Leedham, Lake Oswego, OR (US); Raymond D. Bottenberg, Sheridan, OR (US)

(21) Appl. No.: 13/829,087

(22) Filed: Mar. 14, 2013

Related U.S. Application Data
(60) Provisional application No. 61/705,584, filed on Sep. 25, 2012.

(51) Int. Cl. F16B 5/02

(52) U.S. Cl. CPC F16B 5/02
USPC 29/402.08; 411/237

(57) ABSTRACT

A fastener assembly comprises a beveled flush nut shaped to fit flush to a surface of the first piece within a countersunk portion of a hole, a threaded rod sized to engage the beveled flush nut and to extend through the hole in the first piece and an aligned hole in the second piece. A first nut is sized to threadedly engage the distal end of the threaded rod. A second nut is sized to threadedly engage the proximal end of the threaded rod when extended through an aligned opening in a third piece positioned over the second piece. The threaded engagement at the beveled flush nut can be overcome by tightening the second nut against the third piece, thereby securing the first piece, second piece and third piece together.

### CROSS REFERENCE TO RELATED APPLICATION

This application claims the benefit of U.S. Provisional Patent Application No. 61/705,584, filed Sep. 25, 2012, which is hereby incorporated by reference.

### BACKGROUND

This application relates to fasteners, and in particular to a fastening arrangement or assembly suited to making repairs.

In applications where fasteners are used to hold multiple components, parts or pieces together, it is sometimes necessary to make repairs. If the various pieces can be entirely disassembled all at one time without consequence, making repairs is straightforward. If, however, at least some pieces cannot be entirely disassembled without expensive, difficult and/or awkward preparations, then making repairs is complicated.

For example, repairs to steel bridges can call for adding repair plates over damaged original components that are held in place with rivets or other fasteners. Simply adding a repair plate over the original components usually results in a gap between the repair and the underlying plate due to the heads of the existing rivets. Such a gap can cause moisture to collect and accelerate corrosion.

A repair without gaps between the plates would require disassembling the connection. It is difficult to fully disassemble the connection, however, because the affected plate and fasteners are still carrying part of the bridge's load. To fully disassemble the plate in question may require temporarily supporting the bridge from below, which is time consuming and expensive, even if it is possible.

### SUMMARY

Described herein are approaches to a new fastener assembly that addresses these and other drawbacks in the prior art.

According to one implementation, a fastener assembly for repairing a rivet connecting a first piece to a second piece comprises a beveled flush nut, a threaded rod, a first nut and a second nut. The beveled flush nut is shaped to fit flush to a surface of the first piece within a countersunk hole formed in the first piece at a location where a rivet has been removed. The threaded rod is sized to threadedly engage the beveled flush nut and has a proximal end positioned to extend proximally of the beveled flush nut, and a distal end sized to extend through the hole in the first piece and an aligned hole in the second piece.

The first nut is sized to threadedly engage the distal end of the threaded rod, such that the threaded engagements between (1) the first nut and the threaded rod adjacent the second piece, and (2) the beveled flush nut and the threaded rod adjacent the first piece, are sufficient to secure the first and second pieces together. The second nut is sized to threadedly engage the proximal end of the threaded rod when extended through an aligned opening in a repair piece positioned over the second piece.

The threaded engagement between the beveled flush nut and the threaded rod can be overcome by tightening the second nut against the repair piece. In this way, the first piece, second piece and repair piece are secured together by the threaded engagements between (1) the first nut and the threaded rod adjacent the second piece and (2) the second nut and the threaded rod adjacent the repair piece.

### BRIEF DESCRIPTION OF THE DRAWINGS

FIG. 1 is a side elevation view of a conventional two-piece assembly to be repaired, shown together with a repair plate.

FIG. 2 is a side elevation view in section of the two-piece assembly of FIG. 1 after the repair has been initiated according to the new approach.

FIG. 3 is side elevation view in section showing the two-piece assembly temporarily clamped together by the beveled flush nut, threaded rod and nut.

FIG. 4 a side elevation view of the fastener assembly and repair plate as installed on a completed repair of the two-piece assembly.

FIGS. 5 and 6 are side elevation views similar to FIGS. 3 and 4, respectively, except showing an embodiment where the threaded rod and one nut have been replaced by a bolt.

FIGS. 7, 8 and 9 are side elevation views similar to FIGS. 2-4, respectively, except showing an embodiment where the beveled flush nut is welded to the threaded rod.

FIG. 10 is a top plan view of a beveled flush nut.

FIG. 11 is a side view of a beveled flush nut.

### DETAILED DESCRIPTION

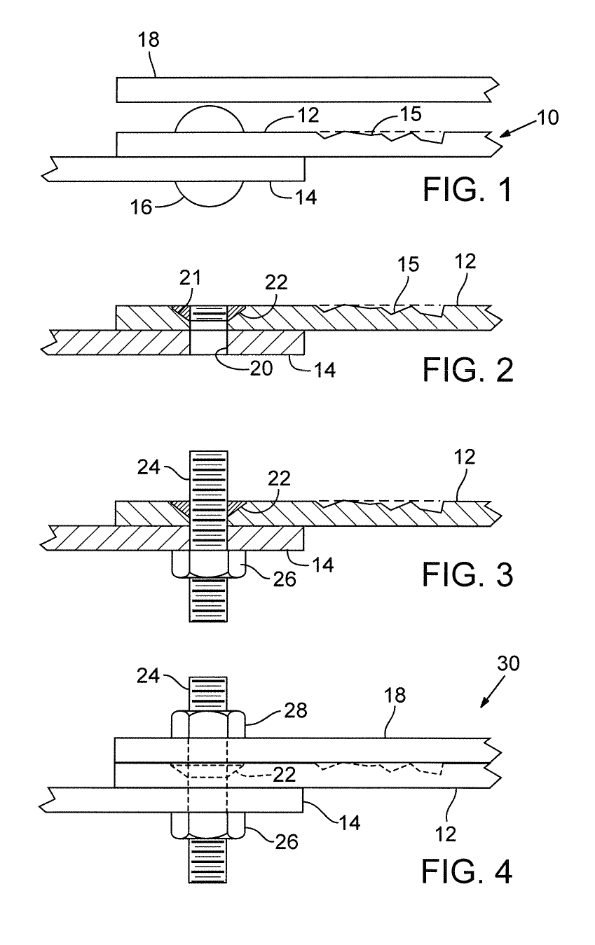

In FIG. 1, a conventional assembly 10 of a first piece 12 connected to an overlapped second piece 14 by a rivet 16 extending through a through hole 20 (FIG. 2) in both pieces is shown. As indicated at an area 15 in the example of FIG. 1, the first piece 12 is in need of repair, e.g., due to loss of material from corrosion. A preferred method of repair includes fitting the first piece 10 with an overlying piece to cover the area 15 and then secure the resulting assembly together.

One form of a suitable overlying piece is a repair plate 18. In FIG. 1, the repair plate 18 is shown aligned with and spaced away from the first piece 12. The repair plate 18 is dimensioned at least as large as the area 15 and to extend to one or more adjacent holes for fastening. According to the conventional approach described above, the repair plate 18 would be attached to the first piece 12 with the gap between these two members remaining because of the presence of one or more of the rivets 16.

According to the new approach as shown in FIGS. 2-4, however, the repair plate 18 is installed adjacent the first piece 12 generally without a significant gap. As shown in FIG. 2, the conventional rivet 16 has been removed to expose a through hole 20 extending through the first piece 12 and the second piece 14. In some examples, there are other rivets or connections between the first piece 12 and the second piece 14 (not shown) that hold these components together even after the rivet 16 is removed. Rivets establish a shear-type connection between the pieces. The through hole 20 has been drilled to define a recess, in this case a countersink 21, to accommodate a threaded fastener, which in this case a beveled flush nut 22. The beveled flush nut 22 has the general shape of an inverted truncated frustro-conical solid with an axial threaded bore.

In FIG. 3, a length of threaded rod 24, also called “allthread” has been threaded through the beveled flush nut and extends through the through hole 20 to the outer side of the second piece 14, where it is secured with a nut 26. Thus, as seen in FIG. 3, the first piece 12 and the second piece 14 are secured together, at least temporarily, by a clamping force exerted by threaded engagement between the beveled flush nut 22 and the threaded rod 24 at one end and the nut 26 and the threaded rod 24 at the other end. The components are preferably designed to have the capacity to replace the conventional rivet's shear capacity with a friction force applied by torqueing one of the nut 26, the beveled flush nut 22 and the threaded rod 24 relative to the other two components. Because of the shape of the beveled flush nut 22, it prevents lateral movement of the clamped assembly, which adds stability during the period before the repair plate 18 is installed.

In some exemplary applications, the threaded rod 24 with the nut 26 attached is passed through the through hole 20 from the second piece side, and then the beveled flush nut 22 is rotated into its recessed position as shown. In other applications, the beveled flush nut 22 is installed first, and the threaded rod is installed from the first piece side of the through hole 20. In typical applications, the connection of the beveled flush nut 22, threaded rod 24 and nut 26 is tightened to a specified torque range, which is selected based upon component sizes, loads, materials, and/or surface treatments, as well as other factors.

In FIG. 4, the repair plate 18 has been fitted over the first piece 12 to cover the area 15 and so that a hole in the repair plate 18 is passed over the protruding end of the threaded rod 24. Because the beveled flush nut 22 is at least flush or even recessed relative to the first piece 12, the repair plate 18 can lay flat against the first piece 12. A nut 28 is threaded onto the protruding end of the threaded rod 24. By torqueing the nut 28 (or the threaded rod 24), a clamping force is exerted between the beveled flush nut 22 and the nut 28 on the repair plate 18. According to the approach described above, the beveled flush nut 22 or the threaded rod 24 in an intermediate section can be designed such that the force exerted by its threads is overcome by a greater force exerted by the nut 28 and the nut 26. In this way, the greater force effectively strips the threads of the beveled flush nut 22 or the mating section of the threaded rod 24, thereby allowing the threaded rod to pass relatively freely through the beveled flush nut 22 without having to be threaded or unthreaded. As a result, the force is exerted by the nut 26, the threaded rod 24 and the nut 28 on the repair plate 18, the second piece 14, and the first piece 12 sandwiched therebetween. Stated differently, the stripping of the threads transfers the clamping force from being exerted by the beveled flush nut 22 and the nut 26 to being exerted by the nut 28 and the nut 26.

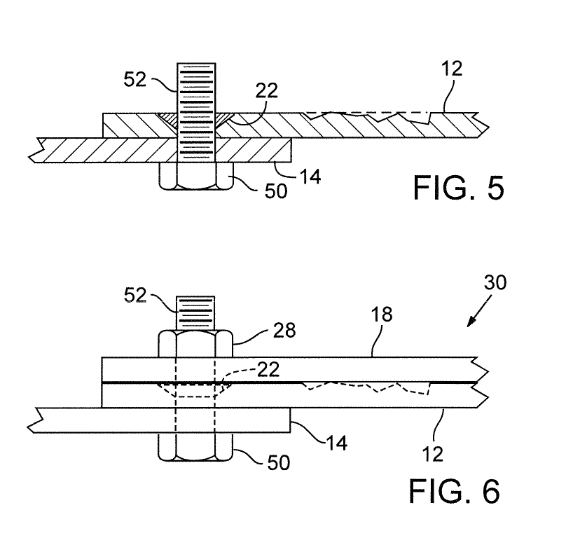

FIGS. 5 and 6 illustrate an embodiment where the nut 26 and the threaded rod 24 are replaced by a bolt. For example, as shown in FIG. 5, the bolt 50 can be inserted from the second piece side, threaded through the beveled flush nut 22 and have its threaded shaft 52 extend beyond the first piece 12. In this way, the repair plate 18 can be installed over the first piece 12 and secured with the nut 28 as shown in FIG. 6. Using a bolt instead of the threaded rod and one of the nuts reduces the number of components and can provide for easier handling and assembly in some circumstances.

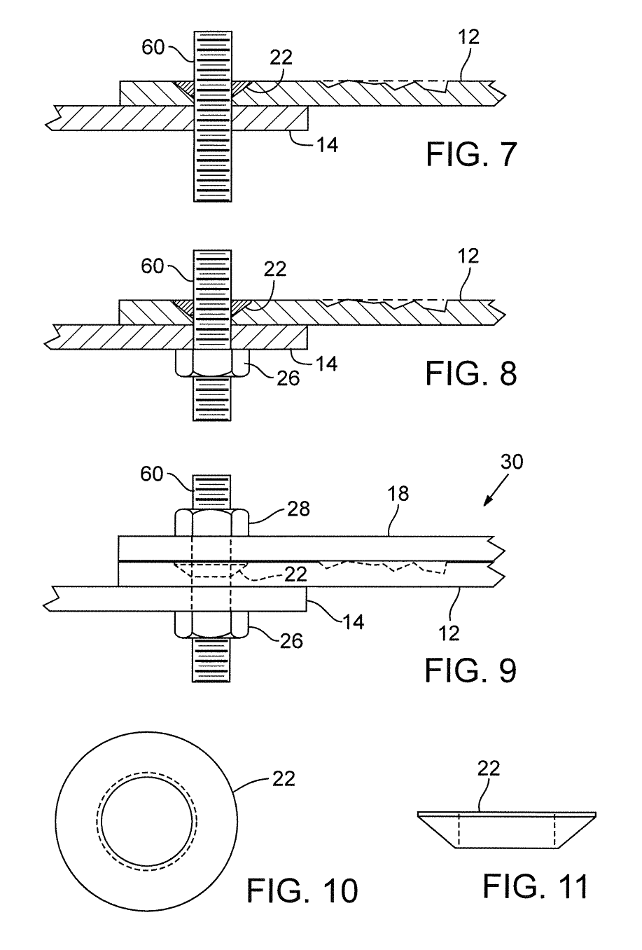

FIGS. 7, 8 and 9 illustrate an embodiment where the threaded rod and the beveled flush nut are joined together by a permanent connection. For example, the beveled flush nut 22 can be included as a portion of the one-piece threaded rod assembly 60. In FIG. 7, the threaded rod assembly 60 is inserted through the through hole 20 until the beveled flush nut portion is against the countersink and with the remaining length of the threaded rod assembly 60 extending beyond the second piece 14. As shown in FIG. 8, the first piece 12 and the second piece 14 are secured together, at least temporarily, by a clamping force exerted by the beveled flush nut portion bearing against the countersink at one end and the threaded connection between the threaded rod assembly 60 and the nut 26 at the other end.

In FIG. 9, the repair plate 18 is installed to lie flat against the first piece 12 and the nut 28 is threaded onto the threaded rod assembly 60. The nut 28 is torqued to a predetermined specification. In some implementations, the torque is selected not to cause the beveled flush portion to separate from the remainder of its threaded rod assembly 60, but rather to lift slightly out of the countersink, which similarly results in transferring the clamping force to the connections at the nut 26 and the nut 28.

FIGS. 10 and 11 are detailed views showing the geometry of the beveled flush nut 22. According to one specific implementation, the beveled flush nut is made of a 4140 steel that is heat treated, and is dimensioned to be received within ⅜″ thick steel plate and with ¾″ threads. Any acceptable bevel angle can be used, such as about 40 degrees. Of course, the dimensions of the various components can be sized to suit the operating requirements of the particular application. The intersection of the first piece 12 and the repair plate 18, as well as other exposed surfaces, can be sealed or treated as appropriate for the conditions, e.g., such as with zinc-rich paint as appropriate.

Thus, the beveled flush nut 22 can be used in at least two modes: (1) as a threaded fastener capable of exerting a clamping force, even if temporary; and (2) as a passive component that passes freely over the threaded rod 24 tensioned at other locations but still allowing adjacent pieces to fit close together. In many applications, the described assembly offers advantages because it allows for step-wise repair of damaged load-bearing connections that otherwise would require separate support. In addition, the repair plate or component can be fit against the original piece requiring repair without gaps.

Although not shown in figures, a conventional flat washer can be provided adjacent the nut 26 and/or adjacent the nut 28. Although the examples above describe two nuts 26 and 28, it would also be possible in some applications to have the nut 28 and the threaded rod 24 replaced by a bolt threaded through the second piece 14, the first piece 12 and the beveled flush nut 22.

In many applications, it is not necessary to take any measures to prevent the beveled flush nut 22 from rotating when not intended. If avoiding such unintended rotation is required, the beveled flush nut 22 can be installed with a thread locking compound or its edge can be set with a punch. Although the described examples highlight the assembly's use in making repairs, the assembly can be used in other applications where multiple pieces are fit closely together, and is particularly suited to holding two or more pieces together until final steps are completed.

We claim:

1. A fastener assembly for repairing a connection between a fastener, a first piece and a second piece, comprising:
a beveled flush nut shaped to fit flush to a surface of the first piece within a countersunk portion of a hole in the first piece at a location where the fastener has been removed;
a threaded rod sized to threadedly engage the beveled flush nut and having a proximal end positioned to extend proximally of the beveled flush nut, and a distal end sized to extend through the hole in the first piece and an aligned hole in the second piece;
a first nut sized to threadedly engage the distal end of the threaded rod, wherein the threaded engagements between the first nut and the threaded rod adjacent the second piece, and the beveled flush nut and the threaded rod adjacent the first piece, are sufficient to secure the first and second pieces together; and
a second nut sized to threadedly engage the proximal end of the threaded rod when extended through an aligned opening in a third piece positioned over the second piece, wherein the threaded engagement between beveled flush nut and the threaded rod can be overcome by tightening the second nut against the third piece, thereby securing the first piece, second piece and third piece together by the threaded engagement between the first nut and the threaded rod adjacent the second piece and threaded engagement between the second nut and the threaded rod adjacent the third piece.

2. The fastener assembly of claim 1, wherein an internal thread of the beveled flush nut is designed to deform when an axial load applied through rotation of the threaded rod exceeds a predetermined force.

3. The fastener assembly of claim 1, wherein a thread of the threaded rod in an intermediate portion is designed to deform when an axial load applied through rotation of the threaded rod exceeds a predetermined force.

4. The fastener assembly of claim 1, further comprising a washer for positioning between the first nut and the second piece.

5. The fastener assembly of claim 1, further comprising a washer for positioning between the second nut and the third piece.

6. The fastener assembly of claim 1, wherein the beveled flush nut is dimensioned to allow the third piece to fit flush against the second piece with the beveled flush nut sandwiched therebetween when the second nut is tightened.

7. The fastener assembly of claim 1, wherein the first piece is a plate with a damaged section, and wherein the third piece is a repair plate shaped to fit over the plate.

8. The fastener assembly of claim 1, wherein the fastener is a rivet.

9. The fastener assembly of claim 1, wherein the fastener is a threaded fastener.

10. A method for repairing a plate and rivet connection, comprising:
removing a first rivet from a first hole;
countersinking the first hole in the first plate;
installing a beveled flush nut in the countersunk first hole;
installing threaded rod to extend through the beveled flush nut at a first end and through the first plate and the second plate at an opposite second end;
tightening a nut at the second end of the threaded rod to clamp the first plate and the second plate together against the beveled flush nut; and
installing a repair plate over the first plate with the repair plate and the first plate contacting each other at least in an area adjacent the first hole, wherein the threaded rod projects through an aligned hole in the repair plate and the beveled flush nut is sandwiched between the first plate and the repair plate.

11. The method of claim 12, further comprising keeping a second rivet spaced from the first rivet intact while the first rivet is removed and replaced by the beveled flush nut, threaded rod and nut.

12. The method of claim 12, further comprising tightening a second nut to clamp the repair plate against the first plate.

13. The method of claim 12, further comprising exerting an axial force through the tightening of the second nut sufficient to overcome a threaded connection between the beveled flush nut and the threaded rod.
